(19) United States
(12) Patent Application Publication
(10) Pub. No.: US 2026/0017757 A1
(43) Pub. Date: Jan. 15, 2026

(54) METHOD, APPARATUS, AND SYSTEM FOR VIDEO ENHANCEMENT, AND STORAGE MEDIUM

(71) Applicant: SAMSUNG ELECTRONICS CO., LTD., Suwon-si (KR)

(72) Inventors: Zihao ZHAO, Jiangsu (CN); Wei Huang, Jiangsu (CN); Yong Zhang, Jiangsu (CN); Zuolong Wang, Jiangsu (CN)

(73) Assignee: SAMSUNG ELECTRONICS CO., LTD., Suwon-si (KR)

(21) Appl. No.: 19/058,948

(22) Filed: Feb. 20, 2025

Related U.S. Application Data
(63) Continuation of application No. PCT/KR2025/099408, filed on Feb. 14, 2025.

(30) Foreign Application Priority Data
Jul. 12, 2024 (CN) 202410941456.1

(51) Int. Cl. G06T 5/30; G06F 3/033; G06T 7/13; G06V 10/26; G06V 10/764; G06V 10/82; G06V 20/70

(52) U.S. Cl. CPC G06T 5/30; G06F 3/033; G06T 7/13; G06V 10/26; G06V 10/764; G06V 10/82; G06V 20/70; G06T 2207/10016; G06T 2207/10024; G06T 2207/20084; G06T 2207/20092; G06T 2207/20192

(57) ABSTRACT

According to an embodiment of the disclosure, the method may include segmenting, using a semantic segmentation technology, an original image into a plurality of semantic objects. According to an embodiment of the disclosure, the method may include identifying a first semantic object from the plurality of semantic object. According to an embodiment of the disclosure, the method may include identifying a first image area corresponding to the first semantic object as a first enhancement area. According to an embodiment of the disclosure, the method may include performing image enhancement on the first enhancement area according to a configured enhancement strategy. According to an embodiment of the disclosure, the method may include providing an enhanced image to a display based on the image enhancement.

### CROSS REFERENCE TO RELATED APPLICATIONS

This application is a bypass continuation application of International Application No. PCT/KR2025/099408, filed Feb. 14, 2025, which is based on and claims priority to Chinese Patent Application No. 202410941456.1, filed on Jul. 12, 2024, the disclosures of which are incorporated by reference herein in their entireties.

### BACKGROUND

### 1. Field

The disclosure relates to the field of Internet technology, and in particular, to a method, apparatus, and system for video enhancement, a computer-readable storage medium, and a computer program product.

### 2. Description of Related Art

Some visually-impaired people, such as people with cataracts, glaucoma, fundus diseases, amblyopia, and pathological myopia, may have challenges when watching a video, but they are still able to perceive differences in light and darkness. Existing display devices typically employ an on-screen display (OSD) to provide visual assistant functions, including high contrast adjustment, image enlargement, and color inversion. However, the related art primarily focuses on full-screen images to make some adjustments, which may result in image clutter, so that it becomes hard for the visually-impaired people to recognize image information, or, which may result in loss of certain parts after enlarging an image, so that it becomes hard for the visually-impaired people to acquire complete information. In addition, in the related art, after OSD configuration, the video image is output in a fixed mode during playback. As a result, visually-impaired people passively receive information and are unable to further obtain additional details about the video image.

### SUMMARY

According to an embodiment of the disclosure, the method may include segmenting, using a semantic segmentation technology, an original image into a plurality of semantic objects. According to an embodiment of the disclosure, the method may include identifying a first semantic object from the plurality of semantic object. According to an embodiment of the disclosure, the method may include identifying a first image area corresponding to the first semantic object as a first enhancement area. According to an embodiment of the disclosure, the method may include performing image enhancement on the first enhancement area according to a configured enhancement strategy. According to an embodiment of the disclosure, the method may include providing an enhanced image to a display based on the image enhancement.

According to an embodiment of the disclosure, an electronic apparatus may be provided. The electronic apparatus may include at least one processor including processing circuitry, memory storing instructions that, when executed by the at least one processor individually or collectively. The at least one processor may cause the electronic apparatus to segment, using a semantic segmentation technology, an original image into a plurality of semantic objects. The at least one processor may cause the electronic apparatus to identify a first semantic object from the plurality of semantic objects, and identify a first image area corresponding to the first semantic object as a first enhancement area. The at least one processor may cause the electronic apparatus to perform image enhancement on the first enhancement area according to a configured enhancement strategy. The at least one processor may cause the electronic apparatus to provide an enhanced image to a display based on the image enhancement.

According to an embodiment of the disclosure, a computer-readable storage medium storing instruction that, when executed by at least one processor, cause the at least one processor to segment, using a semantic segmentation technology, an original image into a plurality of semantic objects. The computer-readable storage medium storing instruction that, when executed by at least one processor, cause the at least one processor to identify a first semantic object from the plurality of semantic object. The computer-readable storage medium storing instruction that, when executed by at least one processor, cause the at least one processor to identify a first image area corresponding to the first semantic object as a first enhancement area. The computer-readable storage medium storing instruction that, when executed by at least one processor, cause the at least one processor to perform image enhancement on the first enhancement area according to a configured enhancement strategy, based on watching patterns of a user. The computer-readable storage medium storing instruction that, when executed by at least one processor, cause the at least one processor to provide an enhanced image to a display based on the image enhancement.

### BRIEF DESCRIPTION OF THE DRAWINGS

The above and other aspects, features, and advantages of embodiments of the present disclosure will be more apparent from the following description taken in conjunction with the accompanying drawings, in which:

FIG. 1 is a flowchart of performing a method for video enhancement according to an embodiment;

FIG. 2 is a partial key diagram of a video blind cane according to an embodiment;

FIG. 3 is a method flowchart of segmenting an original video image into a plurality of semantic subjects according to an embodiment;

FIG. 4 is a diagram of segmenting an original video image into portrait, kite, grassland, and sky semantic subjects according to an embodiment;

FIG. 5 is a process of calculating each semantic subject weight value according to an embodiment;

FIG. 6 is a method flowchart of performing image enhancement according to an embodiment;

FIG. 7 is an image diagram of performing image enhancement according to an embodiment;

FIG. 8 is an original video image used in an embodiment;

FIG. 9A is a flowchart of performing a method for video enhancement according to an embodiment;

FIG. 9B is a flowchart of performing a method for video enhancement according to an embodiment;

FIG. 9C is a flowchart of performing a method for video enhancement according to an embodiment;

FIG. 10 is an image diagram of performing image enhancement according to an embodiment;

FIG. 11 is a structural diagram of an apparatus for video enhancement according to an embodiment; and

FIG. 12 is a structural diagram of a system for video enhancement according to an embodiment.

### DETAILED DESCRIPTION

Various embodiments will be clearly and completely described in combination with the drawings. Based on the embodiments in the disclosure, all other embodiments obtained by those ordinarily skilled in the art fall within the scope of the disclosure.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

The data may be interchanged in appropriate cases so that the one or more embodiments described herein, for example, may be implemented in order other than those illustrated or described here. Furthermore, the terms “include” and “have”, as well as any variations thereof, are intended to cover a non-exclusive inclusion. For example, a process, method, system, product, or device that includes a list of steps or units is not necessarily limited to those steps or units expressly listed, but may include other steps or units not expressly listed or inherent to such process, method, product, or device.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The below one or more embodiments may be combined, and the same or similar concepts or processes may not be described in detail in some embodiments.

For the defects of the related art in providing a fixed video enhancement mode and visually-impaired people receiving information passively, one or more embodiments provide a remote-control device (e.g., a video blind cane). The video blind cane described herein is an apparatus capable of performing remote control operations on the video at a display such as a remote controller. The video blind cane may include such as a handle, and an eye tracker. The video blind cane may remote the display. For example, the video at the display can be remotely controlled by the video blind cane. In reality, visually-impaired people often use blind canes to find their way when they go out. In the one or more embodiments, since a remote control apparatus may be used to scan and operate a video image so as to enable visually-impaired people to perceive video content, which is similar to a blind cane in reality, it is referred to as a “video blind cane”. The visually-impaired people trigger a signal through the video blind cane to perform remote control operations on the video at a display and interact with the video in the process of watching the video, to obtain more information for the interested part, thereby improving the experience of the visually-impaired people watching a video.

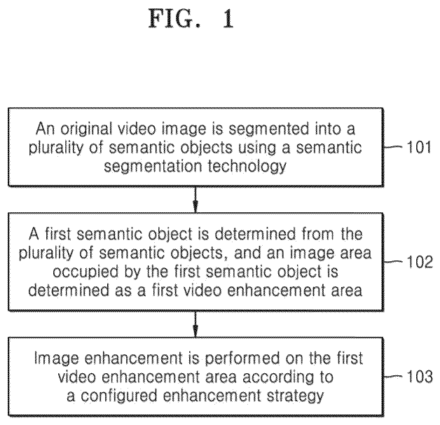

FIG. 1 is a flowchart of performing a method for video enhancement according to an embodiment of the disclosure. As shown in FIG. 1, the method includes the following operations.

In 101, an original video or an original image is segmented into a plurality of semantic objects using a semantic segmentation technology.

During video shooting, there may be semantic objects such as people, animal, building, traffic, sky, and grassland in the image. A semantic object refers to at least one entity with physical meaning perceived within an image. Depending the properties of the at least one entity within an image, an entity may be identified as a semantic object, or a plurality of entities may be identified as a semantic object. When watching the video, it is usually aimed at the semantic object, so the image is segmented according to the semantic object.

In 102, an interesting semantic object is determined from the plurality of semantic objects, and an image area corresponding to the interesting semantic object is determined as a first video enhancement area.

In practical application, video shooting usually takes one or more semantic objects as the focus of the main expression, e.g., interesting semantic objects, based on the principle of narrative photography. Even if a plurality of semantic objects are present in an image, there is often one or more semantic objects to be interested. Therefore, it is useful to determine the interesting semantic object from the plurality of semantic objects as the first video enhancement area to be enhanced. The interesting semantic object may be referred to as the first semantic object.

In 103, image enhancement is performed on the first video enhancement area according to a configured enhancement strategy, based on watching patterns of a user. For example, the image enhancement is performed to satisfy watching demands of the visually-impaired people on the interesting semantic object. Since the interesting semantic object is the focus of the main expression of video shooting, it may need to perform image enhancement for better watching by visually-impaired people.

According to an embodiment, a video image is performed semantic segmentation to determine an interesting semantic object in the video image. Visually-impaired people may use a video blind cane to perform remote control operations on the interesting semantic object, actively exploring the video image and obtaining more detailed information, thereby improving the experience of the visually-impaired people watching a video.

In one or more embodiments, the visually-impaired mode may also be added over the related art. Before switching to the first mode (e.g., visually-impaired mode), the video is displayed in the normal mode, e.g., the original video image. After switching to the first mode (e.g., visually-impaired mode), the video is remotely controlled to adapt user (e.g., visually-impaired people) for watching.

In one or more embodiments, before operation 101 described above, for interacting with the video while watching the video using remote-control device (e.g., the video blind cane), the method may further include: switching, in response to the first mode (e.g., a visually-impaired mode) request signal, a video playback mode to a visually-impaired mode, the first mode (e.g., the visually-impaired mode) request signal being sent by the user (e.g., visually-impaired people) through the remote-control device (e.g., video blind cane) during interaction with the video.

In one or more embodiments, after operation 103 described above, for interacting with the video while watching the video using remote-control device (e.g., the video blind cane), the method may further include: further performing, in response to a video enhancement confirmation signal, image enhancement on the first video enhancement area, the video enhancement confirmation signal being sent by the user (e.g., visually-impaired people) through the remote-control device (e.g., video blind cane) during interaction with the video.

The visually-impaired mode request signal and the video enhancement confirmation signal are signals triggered by user (e.g., visually-impaired people) when interacting with the video in the process of watching the video through the remote-control device (e.g., video blind cane), and the object thereof is to actively perceive the video image.

In one or more embodiments, the image area (e.g., interesting area) may also be extended if the visually-impaired people are not satisfied with the main part in the image and want to further watch other areas. In an embodiment, the method thereof is as follows:

After further performing image enhancement on the first video enhancement area, the method further includes: determining, in response to an enhancement area change signal, a second video enhancement area from the enhancement area change signal, and performing image enhancement on the second video enhancement area, the enhancement area change signal being sent by the user (e.g., visually-impaired people) through the remote-control device (e.g., video blind cane) during interaction with the video.

That is, the visually-impaired people can not only clearly watch the image of the first video enhancement area but also further understand the image of the surrounding area. For example, if the image of a first video enhancement area is a portrait semantic object and the surrounding area has a text description, visually-impaired people can further watch the text description associated with the portrait semantic object to obtain more information.

There are at least two ways to extend the interesting area.

In a first way, in response to the enhancement area change signal being a direction extension signal, the determining a second video enhancement area from the enhancement area change signal includes: acquiring a to-be-extended direction from the direction extension signal, and extending towards the to-be-extended direction when centering on the first video enhancement area, wherein an extension part forms the second video enhancement area.

Specifically, in response to the to-be-extended direction in the direction extension signal being upward, the second video enhancement area is an area enclosed by extending towards an upper-left corner point and an upper-right corner point of the display when centering on the first video enhancement area.

In response to the to-be-extended direction in the direction extension signal being downward, the second video enhancement area is an area enclosed by extending towards a lower-left corner point and a lower-right corner point of the display when centering on the first video enhancement area.

In response to the to-be-extended direction in the direction extension signal being leftward, the second video enhancement area is an area enclosed by extending towards an upper-left corner point and a lower-left corner point of the display when centering on the first video enhancement area.

In response to the to-be-extended direction in the direction extension signal being rightward, the second video enhancement area is an area enclosed by extending towards an upper-right corner point and a lower-right corner point of the display when centering on the first video enhancement area.

In a second way, in response to the enhancement area change signal being a semantic object switching signal, the determining a second video enhancement area from the enhancement area change signal includes: acquiring a direction of a new semantic object from the semantic object switching signal, switching to the direction of the new semantic object when centering on the first video enhancement area, and taking an image area occupied by the new semantic object as the second video enhancement area.

That is, the second video enhancement area may be another geometric area or another area occupied by a semantic object as long as it extends outward from the first video enhancement area.

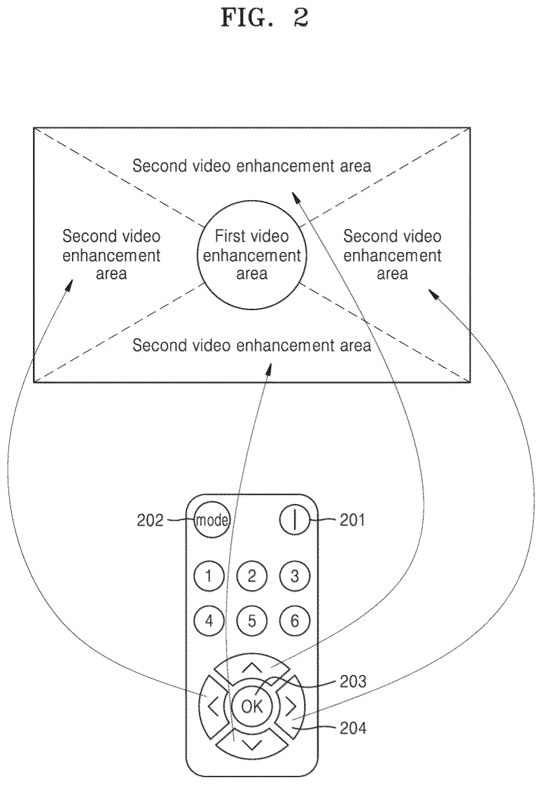

In one or more embodiments, FIG. 2 may be a partial key diagram of a video blind cane according to an embodiment. As shown in FIG. 2, the remote-control device (e.g., video blind cane) includes at least first key (e.g., an on-off key 201), a second key (e.g., a mode key 202), a third key (e.g., a confirmation key 203), a fourth key (e.g., a direction key 204), and may include other numeric keys. The mode key, confirmation key, and direction key of the video blind cane described in the one or more embodiments, may be specific keys of the video blind cane, or keys multiplexed in a common remote controller. For example, in an ordinary television remote controller, when the visually-impaired people switch the video playback mode to the visually-impaired mode, the function of the confirmation key and the direction key will be taken over by the ordinary television remote controller. The confirmation key and the direction key of the common television remote controller no longer perform the original functions, but perform the functions described in the one or more embodiments, and send a video enhancement confirmation signal and a direction extension signal. In practical application, the video blind cane may be a television remote controller, a handle, an eye tracker, a mobile device, augmented reality (AR), virtual reality (VR), and a camera, and may be controlled according to eye movement, gesture, and voice recognition, and is not limited in one or more embodiments, as long as it can interact with the video.

The various signals described above may be sent as follows:
(1) The visually-impaired mode request signal is sent by pressing the mode key in the video blind cane.
(2) The video enhancement confirmation signal is sent by pressing the confirmation key in the video blind cane.
(3) The enhancement area change signal (direction extension signal or semantic object switching signal) is sent by pressing the direction key in the video blind cane.

Further, when stopping pressing the confirmation key or the direction key, e.g., the confirmation key or the direction key is released, the corresponding video enhancement confirmation signal or the direction extension signal will be interrupted.

In an embodiment, the further performing image enhancement is canceled for the first video enhancement area in response to interruption of the video enhancement confirmation signal. In practical application, the interruption of the video enhancement confirmation signal may be triggered by the visually-impaired people releasing the confirmation key in the video blind cane; after canceling the further performing image enhancement, the original video image may be restored, or the image enhancement may be continued on the first video enhancement area according to the image enhancement mode after switching to the visually-impaired mode.

The image enhancement is canceled for the second video enhancement area in response to interruption of the enhancement area change signal. In practical application, the interruption of the enhancement area change signal may be triggered by the visually-impaired people releasing the direction key in the video blind cane, and the original video image may be restored after the image enhancement is canceled.

It is an example to illustrate the interaction between visually-impaired people and the video using a video blind cane, and the specific operation mode is not intended to limit the scope of the disclosure.

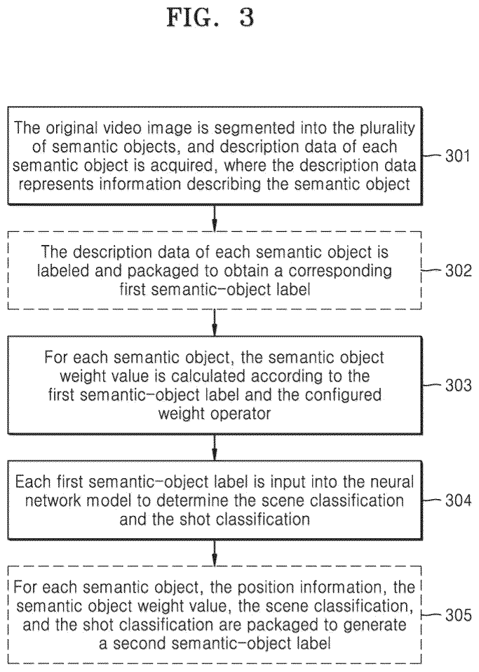

In one or more embodiments, a method of segmenting an original video image into a plurality of semantic objects using a semantic segmentation technology may be as follows. FIG. 3 is a method flowchart of segmenting an original video image into a plurality of semantic objects according to an embodiment; As shown in FIG. 3, the method includes the following operations.

In 301, the original video image is segmented into the plurality of semantic objects, and description data of each semantic object is acquired, where the description data represents information describing the semantic object.

For example, the description data may include at least one of position information, semantic classification, occurrence frequency, image proportion information, image center offset value, spatial orientation distance, average light and shadow brightness value, and edge grayscale change rate.

As described above, the semantic objects refer to entities with physical meaning, such as people, animal, building, traffic, sky, and grassland. In practical application, the first neural network may be used to segment the image into a plurality of semantic objects. To better describe the semantic objects, the description data of each semantic object is acquired in the step. The position information refers to the position of the semantic object in the image and may be represented by a two-dimensional coordinate of the image. Semantic classification is the category of semantic object, for example, people, animal, building, traffic, sky, and grassland. The occurrence frequency refers to the number of times the category of the semantic object appears in the same image, for example, if there are three people in the image, the occurrence frequency of the semantic object of people is three. The image proportion information refers to the proportion of the size of the semantic object in the whole image. The image center offset value refers to an offset distance of the semantic object away from the whole image center. The spatial orientation distance refers to the distance between the semantic object and the shooting lens. The average light and shadow brightness value refers to the average brightness values of all pixel points inside the area of the semantic object. The edge grayscale change rate refers to the grayscale change rate of the edge of the semantic object. In practical application, other description data may also be included, and will not be listed one by one here.

In 302, the description data of each semantic object is labelled and packaged to obtain a corresponding first semantic-object label.

The acquired description data is single data, and it may be difficult to completely represent a semantic object. In an embodiment, all the description data are labelled and packaged to generate a first semantic-object label. The first semantic-object label is a description of one semantic object, and if an image is segmented into a plurality of semantic objects, a plurality of first semantic-object labels are generated correspondingly. In practical application, if description data of each semantic object is acquired, the description data may not be labelled and packaged, i.e., operation 302 is omitted.

In 303, for each semantic object, the semantic object weight value is calculated according to the first semantic-object label and the configured weight operator.

The first semantic-object label contains description data. A part of description data may be directly extracted from an image, such as position information, occurrence frequency, image proportion information, image center offset value, spatial orientation distance, average light and shadow brightness value, and edge grayscale change rate. Another part of description data may be computed through neural networks, such as semantic classification. Whether extracted directly from the image or computed through the neural networks, the description data has corresponding values. Although these description data are all data reflecting semantic objects, the importance of each description data is different. To indicate different importance of each description data, different weights may be configured for different description data in the one or more embodiments. For example, semantic classification is an entity that mainly expresses the semantic object, and whether the semantic object occupies the image center or not, therefore, a relatively high weight may be configured for the semantic classification and the image center offset value. How to specifically configure a weight may be determined according to actual situations, and does not limit the scope of the disclosure. In an embodiment, a weight configured for each description data is referred to a weight operator. All or part of the description data are multiplied by the corresponding weights to obtain a sum value and the sum value is referred to as a semantic object weight value. The semantic object weight value can reflect the importance of semantic object.

In 304, each first semantic-object label is input into the neural network model to determine the scene classification and the shot classification.

Scene classification refers to scenes represented by images, such as portrait, scenery, traffic, animal, and food. Shot classification refers to the difference of a range size displayed by the subject in the camera video recorder due to the different distance between the camera and the semantic object when the focal length is fixed. The shot may be divided into five types, that is, close-up, close shot, medium shot, full shot, and long shot. The first semantic-object label contains description data to be used to determine the shot classification. For example, the semantic classification of a certain semantic object is people, the image proportion information is great, the position information and the image center offset value reflect that the semantic object is located in the middle of the image, and it may be determined from these description data that the scene classification of the image is a portrait, and the shot classification is a close-up. To better distinguish, in practical application, a large number of samples may be used for training to generate neural networks, to accurately determine the scene classification and the shot classification. To distinguish from the neural network of step 301, the neural network herein may be referred to as a second neural network.

In 305, each semantic object, the position information, the semantic object weight value, the scene classification, and the shot classification are packaged to generate a second semantic-object label. The first semantic-object label, semantic object weight value, scene classification, and shot classification have been obtained through the above steps 301 to 304. In the one or more embodiments, the above information will be used subsequently for image enhancement. In the process of image enhancement, it is useful to select an interesting semantic object and use an enhancement strategy for image enhancement in the one or more embodiments. The interesting semantic object and the semantic object weight value are selected, and the enhancement strategy is related to position information, scene classification, and shot classification. Therefore, in step 305, the position information, semantic object weight value, scene classification, and shot classification are packaged to generate a second semantic-object label. In practical application, as long as the position information, the semantic object weight value, the scene classification, and the shot classification are determined, the position information, semantic object weight value, scene classification, and shot classification may not be packaged to generate the second semantic-object label, that is, operation 305 may be omitted.

According to an embodiment, a semantic segmentation technology is used to segment an original video image into a plurality of semantic objects, and a second semantic-object label is acquired, so that subsequent image enhancement may be continued. In an embodiment, a first neural network is used to segment an image into a plurality of semantic objects, a second neural network is used to determine a scene classification and a shot classification, and description data and a weight operator are used to accurately calculate a first semantic-object label and a second semantic-object label, thereby improving the accuracy of subsequent image enhancement on the interesting semantic object.

In one or more embodiments, after an image is segmented into a plurality of semantic objects, the interesting semantic object may be determined from the plurality of semantic objects, and then image enhancement may be performed only on the interesting semantic object, without performing image enhancement on other parts, so at to highlight the interesting semantic object, which is more beneficial for the visually-impaired people watching.

Specifically, the method for determining interesting semantic object from the plurality of semantic objects may be implemented as follows: ranking all the semantic objects according to semantic object weight values; and selecting, according to a number to be enhanced, the number of semantic objects as interesting semantic objects according to the ranking.

As described above, the semantic object weight value reflects the importance of the semantic object, so all the semantic objects in the image may be ranked from high to low according to the semantic object weight values. The first-ranked semantic object is the most important, followed by the second-ranked semantic object, and so on. The user watching a video is accustomed to watching the most important semantic object, so the first-ranked semantic object may be used as an interesting semantic object for image enhancement. In practical application, the number of enhancements may be pre-configured, a corresponding number of semantic objects may be selected as the interesting semantic objects according to the ranking, and one or more interesting semantic objects may be performed image enhancement at the same time. As to how to configure the number of enhancements, it may be configured adaptively according to actual situations. In practical application, a semantic object weight value threshold may also be configured, and the semantic object with a semantic object weight value exceeding the semantic object weight value threshold is taken as the interesting semantic object.

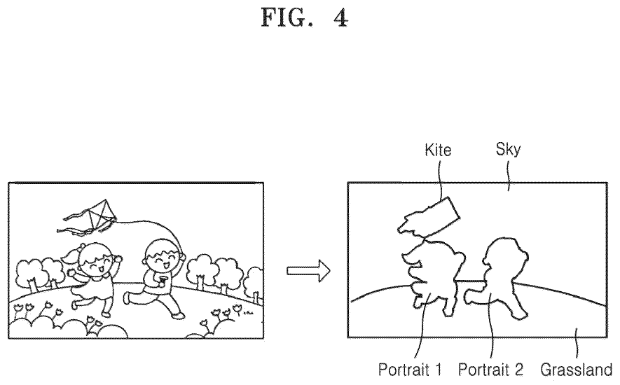

As shown in FIG. 4, the method of the above embodiments may be used to segment an original video image into four semantic objects in total, that is, portrait, grassland, sky, and kite. The portrait has two individual semantic objects, including portrait 1 and portrait 2. For convenience of description, one of the portraits is described below, and the other portraits are similar.

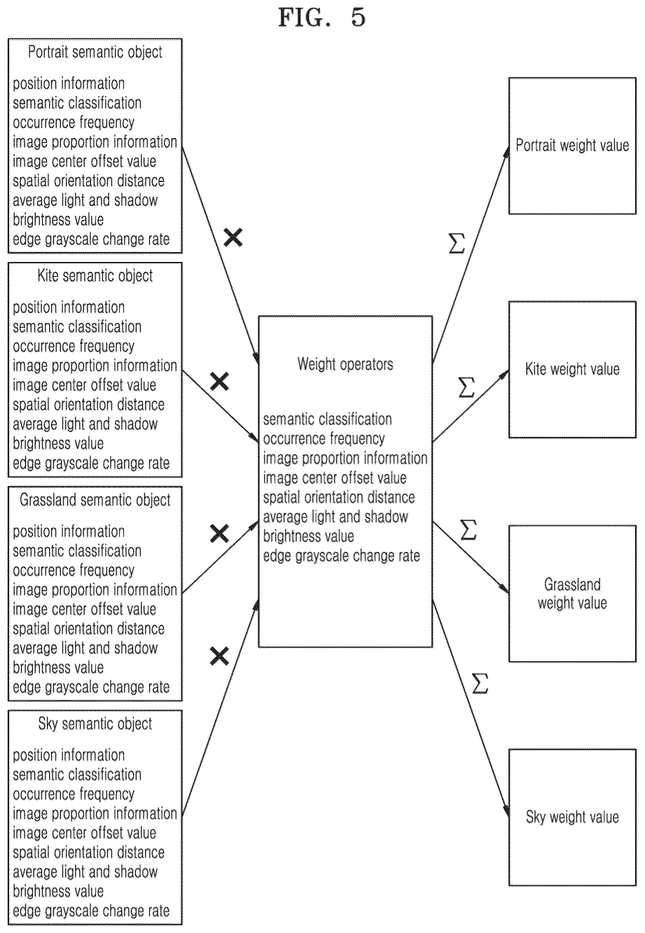

FIG. 5 is a process of calculating each semantic object weight value according to an embodiment. As shown in FIG. 5, description data is acquired for each semantic object, for example, portrait, kite, grassland, and sky; the description data of each semantic object is labelled and packaged to obtain a corresponding first semantic-object label.

For example, the description data of the portrait semantic object are as follows: semantic classification=0.5, occurrence frequency=2, image proportion information=0.205, image center offset value=0.69, spatial orientation distance=0.708, average light and shadow brightness value=0.75, and edge grayscale change rate=0.97. In addition, the description data of the portrait semantic object may further include position information, which may be represented by four coordinates in the upper, lower, left, and right, such as (x11, y11), (x12, y12), (x13, y13), and (x14, y14).

For example, the description data of the kite semantic object are as follows: semantic classification=0.4, occurrence frequency=1, image proportion information=0.068, image center offset value=0.407, spatial orientation distance=0.646, average light and shadow brightness value=0.9, and edge grayscale change rate=0.35. In addition, the description data of the kite semantic object may further include position information, which may be represented by four coordinates in the upper, lower, left, and right, such as (x21, y21), (x22, y22), (x23, y23), and (x24, y24).

For example, the description data of the grassland semantic object are as follows: semantic classification=0.2, occurrence frequency=1, image proportion information=0.168, image center offset value=0.566, spatial orientation distance=0.88, average light and shadow brightness value=0.73, and edge grayscale change rate=0.36. In addition, the description data of the grassland semantic object may further include position information, which may be represented by four coordinates in the upper, lower, left, and right, such as (x31, y31), (x32, y32), (x33, y33), and (x34, y34).

For example, the description data of the sky semantic object are as follows: semantic classification=0.15, occurrence frequency=1, image proportion information=0.103, image center offset value=0.463, spatial orientation distance=0.45, average light and shadow brightness value=0.91, and edge grayscale change rate=0.43. In addition, the description data of the sky semantic object may further include position information, which may be represented by four coordinates in the upper, lower, left, and right, such as (x41, y41), (x42, y42), (x43, y43), and (x44, y44).

For example, the weight operators for the semantic classification, occurrence frequency, image proportion information, image center offset value, spatial orientation distance, average light and shadow brightness value, and edge grayscale change rate may be 0.2, 0.1, 0.1, 0.2, 0.05, 0.1, and 0.15, respectively.

In an embodiment, for each semantic object, the semantic object weight value is calculated according to the first semantic-object label and the configured weight operator. The weight value may be the sum of the weight operator values corresponding to the description data and description data.

For example, the portrait weight value is calculated as [0.5, 2, 0.205, 0.69, 0.708, 0.75, 0.97]*[0.2, 0.1, 0.1, 0.2, 0.05, 0.1, 0.15]=0.7144.

For example, the kite weight value is calculated as [0.4, 1, 0.068, 0.407, 0.646, 0.9, 0.35]*[0.2, 0.1, 0.1, 0.2, 0.05, 0.1, 0.15]=0.4423.

For example, the grassland weight value is calculated as [0.2, 1, 0.168, 0.566, 0.88, 0.73, 0.36]*[0.2, 0.1, 0.1, 0.2, 0.05, 0.1, 0.15]=0.441.

For example, the sky weight value is calculated as [0.15, 1, 0.103, 0.463, 0.45, 0.91, 0.43]*[0.2, 0.1, 0.1, 0.2, 0.05, 0.1, 0.15]=0.4109.

Thereafter, for each semantic object, the position information, the semantic object weight value, the scene classification, and the shot classification are packaged to generate a second semantic-object label. Furthermore, the semantic objects may be ranked based on a weight, and then a portrait is the first semantic object, a kite is the second semantic object, a grassland is the third semantic object, and a sky is the fourth semantic object.

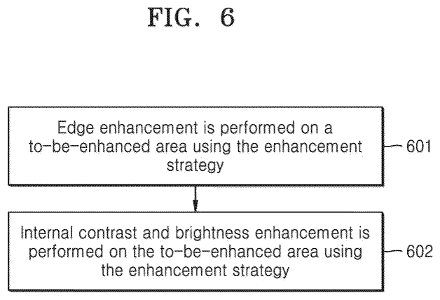

In one or more embodiments, the image enhancement may take the following method. The image enhancement of a first video enhancement area in step 103 of an embodiment of the above method, the image enhancement of a second video enhancement area, or image enhancement performed in other methods, may be implemented using the methods in one or more embodiments. FIG. 6 is a method flowchart of performing image enhancement according to an embodiment. As shown in FIG. 6, the method includes the following operations.

In 601, edge enhancement is performed on a to-be-enhanced area using the enhancement strategy.

Alternatively or additionally, in 602, internal contrast and brightness enhancement is performed on the to-be-enhanced area using the enhancement strategy.

The image enhancement methods may be divided into at least three types: The first may be to perform edge enhancement only; the second may be to perform internal contrast and brightness enhancement only; the third may be to perform edge enhancement and internal contrast and brightness enhancement simultaneously. The methods for edge enhancement are as follows.
(1) Edge detection is performed on the to-be-enhanced area using the filter configured in the enhancement strategy. The filter may select a Sobel filter of 3*3 or 5*5, to calculate the gradient size.
(2) Edge expansion is performed on the to-be-enhanced area using the dilation operator configured in the enhancement strategy.
(3) Edge coloring is performed on the to-be-enhanced area using the color configured in the enhancement strategy. To highlight the display of the area contour, edge coloring may be performed adopting the color opposite to the area.

Edge detection, edge expansion, and edge coloring as described herein may be implemented in the related art and will not be described in detail. The contour of the semantic object is expanded and colored with other colors, so that the visually-impaired people can capture the semantic objects in the image, thereby achieving the effect of watching. In addition, the contrast and brightness of the internal image of the area may be increased so that the visually-impaired people can capture more image details. In one or more embodiments, to better highlight the interesting semantic object, the contrast and brightness of the internal image of the area may be improved while the contrast and brightness of the non-interesting semantic objects may be reduced.

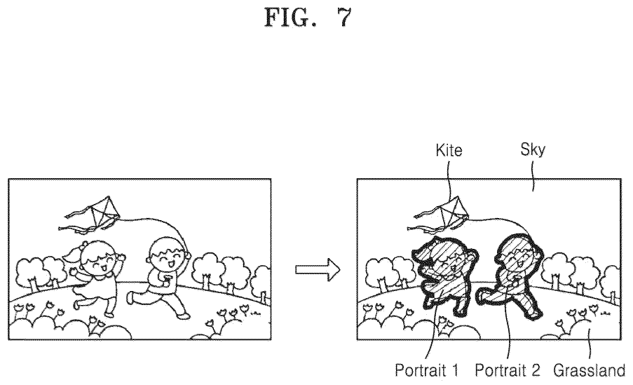

Using the original video image in FIG. 4 as an example, the image area occupied by the first semantic object portrait is the first video enhancement area; the first video enhancement area after image enhancement is shown in FIG. 7. A bold line is used at the edge of the portrait area to represent edge enhancement and a diagonal line is used in the interior of the area to represent contrast and brightness enhancement.

As described above in operations 601 and 602, the configured enhancement strategy may be used when performing image enhancement in the one or more embodiments. In one or more embodiments, image enhancement may be performed separately on different scene classifications and shot classifications, and the enhancement strategies are configured according to the scene classifications and shot classifications. The scene classification represents a category of a scene represented by the semantic object, and the shot classification represents a difference of a range size displayed by a semantic object on the image when a focal length is fixed. In combination with a camera theory, different scene classifications and different shot classifications are classified with different enhancement strategies. If the scene is divided into portrait, scenery, traffic, animal, object, and the shot is divided into close-up, close shot, medium shot, full shot, and long shot, and the enhancement strategies thereof may be as follows:

For a semantic object of which scene classification is portrait, scenery, animal, or object, when the semantic object is farther away from a lens in the shot classification, the contrast, brightness, and a dilation operator are larger, and a sensitivity parameter of a filter is smaller. When the distance is larger, more contrast and brightness of the contour and the area may need to be enhanced, to provide better discrimination. When the distance is smaller, the filter may need to be enhanced, to capture details. For a semantic object of which scene classification is traffic, when the semantic object is farther away from a lens in the shot classification, the contrast, brightness, and sensitivity parameter of the filter are larger, and the smaller the dilation operator is smaller. When the distance is larger, it is more useful to strengthen the details in the area and weaken the contour.

The enhancement strategy may be an image enhancement strategy that adjusts a value of the image. The value of the image may include value of at least one of internal contrast, brightness, parameter of the filter or dilation operator. For example, the enhancement strategy may vary based on shot classification and scene classification.

For example, several possible enhancement strategy solutions are listed below.
(1) The enhancement strategy for a scene category of portrait is shown in Table 1 below.

TABLE 1

| | | | | Dilation |
|---|---|---|---|---|
| | Contrast | Brightness | Filter | operator |
| Long shot | +60% | +70% | −50% | +50% |
| Full shot | +40% | +50% | −30% | +30% |
| Medium shot | +20% | +20% | +10% | +10% |
| Close shot | +10% | +20% | +30% | +0% |
| Close-up | +5% | +10% | +40% | +0% |

(2) The enhancement strategy for a scene category of scenery is shown in Table 2 below.

TABLE 2

| | | | | Dilation |
|---|---|---|---|---|
| | Contrast | Brightness | Filter | operator |
| Long shot | +80% | +80% | 0% | +30% |
| Full shot | +70% | +60% | +20% | +20% |
| Medium shot | +60% | +40% | +30% | +20% |
| Close shot | +40% | +30% | +30% | +10% |
| Close-up | +20% | +20% | +40% | +10% |

(3) The enhancement strategy for a scene category of traffic is shown in Table 3 below.

TABLE 3

| | | | | Dilation |
|---|---|---|---|---|
| | Contrast | Brightness | Filter | operator |
| Long shot | +70% | +50% | +40% | +0% |
| Full shot | +50% | +40% | +20% | +10% |
| Medium shot | +30% | +20% | +0% | +20% |
| Close shot | +10% | +10% | −30% | +30% |
| Close-up | +0% | +0% | −50% | +40% |

(4) The enhancement strategy for a scene category of animal is shown in Table 4 below.

TABLE 4

| | | | | Dilation |
|---|---|---|---|---|
| | Contrast | Brightness | Filter | operator |
| Long shot | +50% | +70% | −60% | +60% |
| Full shot | +40% | +50% | −40% | +40% |
| Medium shot | +20% | +20% | +0% | +20% |
| Close shot | +10% | +10% | +20% | +10% |
| Close-up | +0% | +10% | +30% | +0% |

(5) The enhancement strategy for a scene category of object is shown in Table 5 below.

TABLE 5

| | | | | Dilation |
|---|---|---|---|---|
| | Contrast | Brightness | Filter | operator |
| Long shot | +40% | +70% | −50% | +30% |
| Full shot | +30% | +50% | −30% | +20% |
| Medium shot | +20% | +30% | −10% | +10% |
| Close shot | +10% | +20% | +10% | +10% |
| Close-up | +0% | +10% | +20% | +0% |

As shown in the above Tables 1 to 5, for images of portrait, scenery, animal, and object, when the semantic object is farther away from a lens in the shot classification, the contrast, brightness, and a dilation operator are larger, and a sensitivity parameter of a filter is smaller. For an image of traffic, the farther away from the lens, when the semantic object is farther away from a lens in the shot classification, the contrast, brightness, and sensitivity parameter of the filter are larger, and the smaller the dilation operator is smaller. In practical application, the enhancement strategy may be flexibly configured according to situations as long as the effect of watching by the visually-impaired people is not affected.

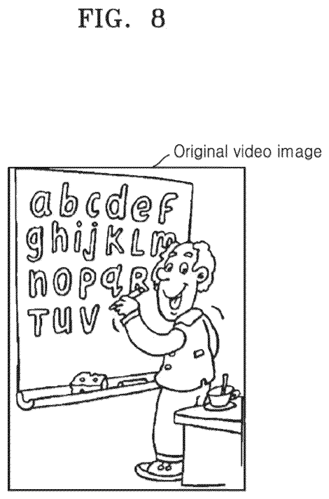

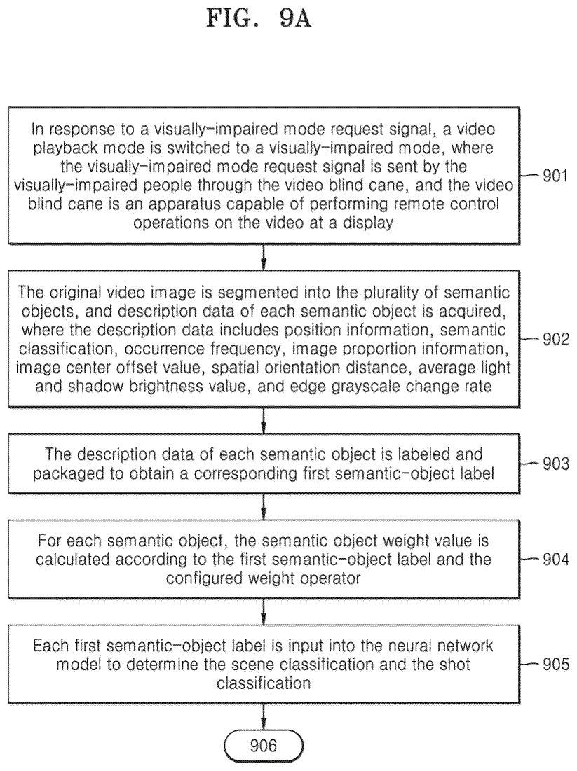

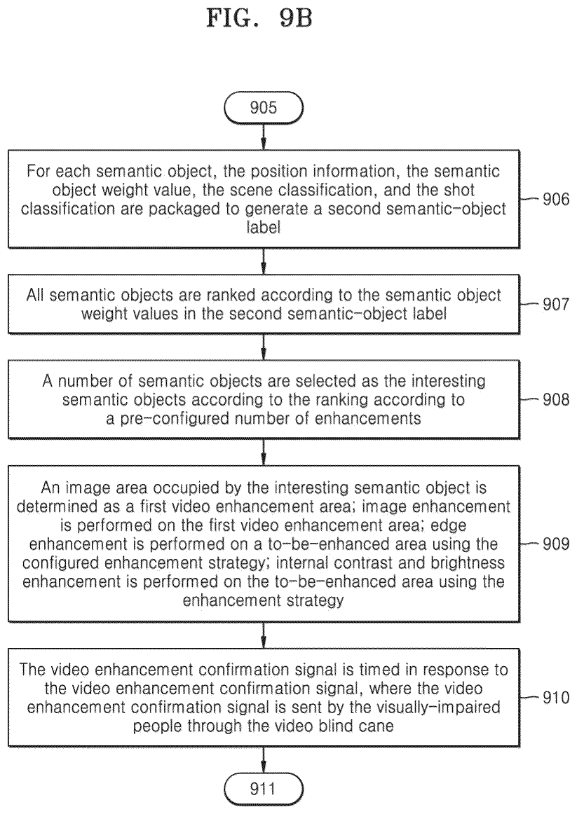

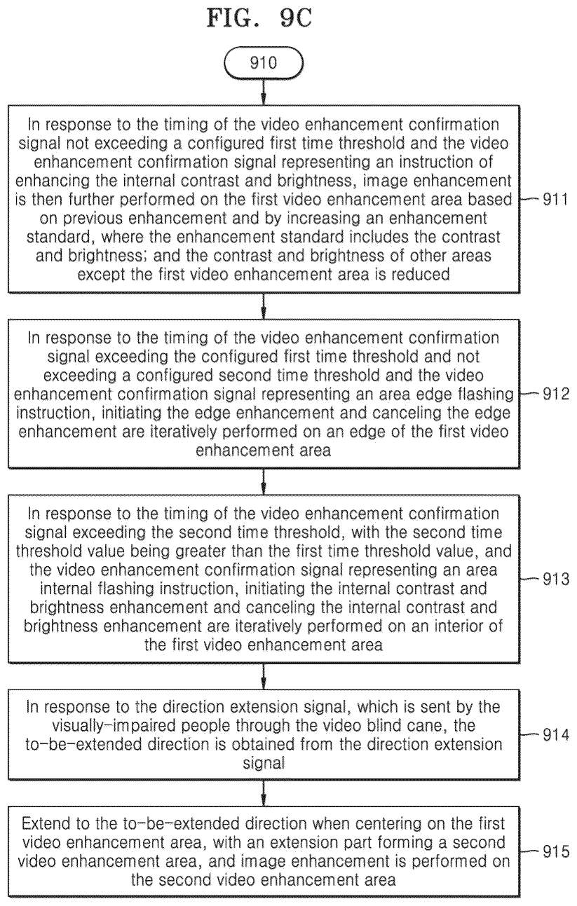

FIG. 8 is an original video image. FIGS. 9A, 9B and 9C is a flowchart of performing a method for video enhancement according to an embodiment. As shown in FIGS. 9A, 9B and 9C, the method includes the following operations.

In 901, in response to a visually-impaired mode request signal, a video playback mode is switched to a visually-impaired mode, where the visually-impaired mode request signal is sent by the visually-impaired people through the video blind cane, and the video blind cane is an apparatus capable of performing remote control operations on the video at a display.

If the visually-impaired people press the mode key of the video blind cane shown in FIG. 2, the video may be switched to the visually-impaired mode, and the function of the confirmation key and direction key of the remote control apparatus may be taken over.

The following operations 902 to 906 are a method for segmenting an original video image into a plurality of semantic objects using a semantic segmentation technology, which are the same as operations 301 to 305 of the method. The operations are as follows.

In operation 902, the original video image is segmented into the plurality of semantic objects, and description data of each semantic object is acquired, where the description data includes position information, semantic classification, occurrence frequency, image proportion information, image center offset value, spatial orientation distance, average light and shadow brightness value, and edge grayscale change rate.

Here, the original video image is segmented into several parts, including portrait, blackboard, desk, and text; description data of each semantic object is obtained. The specific data can refer to the actual situation and is omitted here.

In operation 903, the description data of each semantic object is labelled and packaged to obtain a corresponding first semantic-object label.

In operation 904, each semantic object, the semantic object weight value is calculated according to the first semantic-object label and the configured weight operator.

In operation 905, each first semantic-object label is input into the neural network model to determine the scene classification and the shot classification.

The scene classification determined in the step may be portrait and the shot classification may be close shot.

In operation 906, each semantic object, the position information, the semantic object weight value, the scene classification, and the shot classification are packaged to generate a second semantic-object label.

In an embodiment, a semantic segmentation technology is used to segment an original video image into a plurality of semantic objects, and a second semantic-object label is acquired, so that subsequent image enhancement may be continued. The following operations 907 to 915 all belong to the process of image enhancement. The interesting semantic object is determined from the plurality of semantic objects in operations 907 to 908; image enhancement is performed on the interesting semantic object in operation 909; the interesting semantic object is further performed image enhancement according to the video enhancement confirmation signal in operations 910 to 913; the surrounding area is further performed image enhancement according to the direction extension signal in operations 914 to 915.

In operation 907, all semantic objects are ranked according to the semantic object weight values in the second semantic-object label.

In the step, all the semantic objects are ranked according to the semantic object weight values in the second semantic-object label; the ranking result may be that the portrait is a first semantic object, the blackboard is a second semantic object, the desk is a third semantic object, and the text is a fourth semantic object.

In operation 908, a number of semantic objects are selected as the interesting semantic objects according to the ranking according to a pre-configured number of enhancements.

In the step, if the number of enhancements is pre-configured to 1, only portrait semantic object is selected as the interesting semantic object according to the ranking of semantic objects.

In operation 909, an image area occupied by the interesting semantic object is determined as a first video enhancement area; image enhancement is performed on the first video enhancement area; edge enhancement is performed on a to-be-enhanced area using the configured enhancement strategy; internal contrast and brightness enhancement is performed on the to-be-enhanced area using the enhancement strategy.

In an embodiment, the portrait semantic object in the image will be enhanced as the interesting semantic object, including edge enhancement and area internal enhancement. The edge enhancement includes performing edge detection on the to-be-enhanced area using a filter configured in the enhancement strategy. The filter may select a Sobel filter of 3*3 or 5*5 to calculate the gradient size. Edge expansion is performed on the to-be-enhanced area using the dilation operator configured in the enhancement strategy. Edge coloring is performed on the to-be-enhanced area using the color configured in the enhancement strategy. To highlight the display of the area contour, edge coloring may be performed adopting the color opposite to the area. The area internal enhancement can improve the internal contrast and brightness of the portrait semantic object.

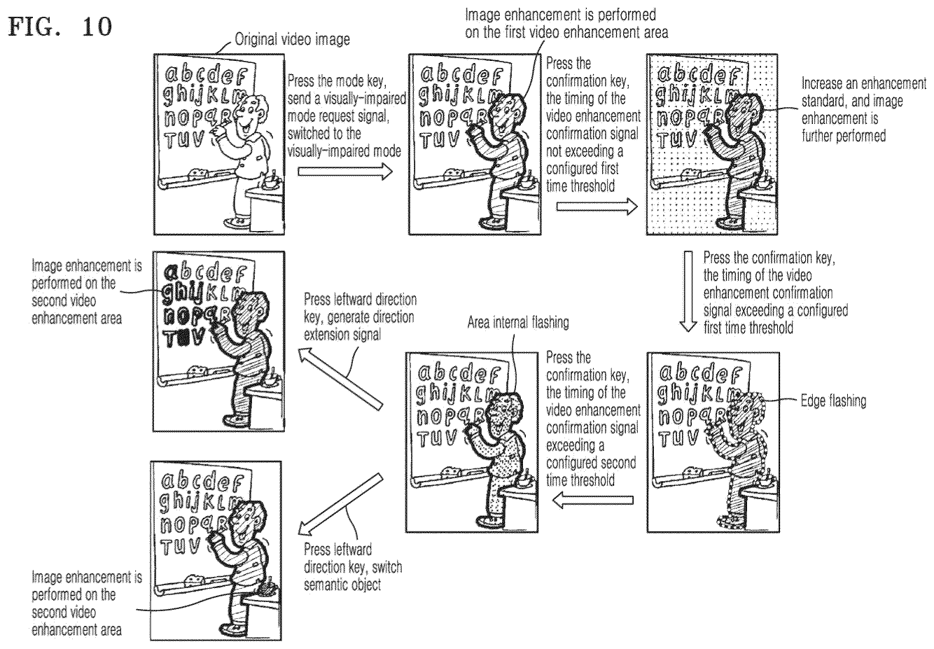

FIG. 10 is an image diagram of performing image enhancement according to an embodiment. The first image is the original video image, and the second image indicates that after the visually-impaired people press the mode key on the video blind cane, image enhancement is performed on the portrait semantic object in the image as the interesting semantic object. The contour of the portrait semantic object indicates edge enhancement with bold lines, and the sparse diagonal lines in the interior of the area indicate that the contrast and brightness are improved.

In 910, the video enhancement confirmation signal is timed in response to the video enhancement confirmation signal, where the video enhancement confirmation signal is sent by the visually-impaired people through the video blind cane.

In 911, in response to the timing of the video enhancement confirmation signal not exceeding a configured first time threshold and the video enhancement confirmation signal representing an instruction of enhancing the internal contrast and brightness, image enhancement is then further performed on the first video enhancement area based on previous enhancement and by increasing an enhancement standard, where the enhancement standard includes the contrast and brightness; and the contrast and brightness of other areas except the first video enhancement area is reduced.

In the above operations 910 to 911, the visually-impaired people may press the confirmation key on the video blind cane. The confirmation key of the one or more embodiments has a multiplexing function to distinguish different requirements of the visually-impaired people according to the timing of the video enhancement confirmation signal. The first time threshold may be configured to 2 seconds, and the second time threshold is configured to 5 seconds. In the case where the confirmation key on the video blind cane is pressed for not more than 2 seconds, operation 911 is performed, that is, the portrait semantic object is enhanced again on the basis that it has been enhanced in operation 909, the contrast and brightness is continued to increase, and the contrast and brightness of other areas is decreased. In an embodiment, the contrast and brightness may continue to increase only, without continue to perform edge enhancement, and the existing edge enhancement effect of operation 909 keeps unchanged. In one or more embodiments, image enhancement is then further performed on the first video enhancement area based on previous enhancement and by increasing an enhancement standard, where the enhancement standard may further include edge enhancement, i.e., edge enhancement is continued to perform and the internal contrast and brightness is improved in the first video enhancement area in operation 911.

In the one or more embodiments, when image enhancement is performed again, it is also possible to reduce the contrast and brightness of other areas except the first video enhancement area. This is to highlight the first video enhancement area by reducing the contrast and brightness of other areas, while not adjusting the contrast and brightness of the first video enhancement area to be much high. In one or more embodiments, the contrast and brightness of other areas except the first video enhancement area may not be reduced so long as the watching effect of the visually-impaired people is not affected.

The third image of FIG. 10 indicates that the effect of the portrait semantic object in the image is subjected to continuous image enhancement as the interesting semantic object when the visually-impaired people press the confirmation key on the video blind cane for less than 2 seconds. The denser diagonal line is used in the interior of the area to indicate that the enhancement standard is improved to perform image enhancement again, and the contrast and brightness continue to be improved; the black dots in other areas indicate that the contrast and brightness are reduced.

In operation 912, in response to the timing of the video enhancement confirmation signal exceeding the configured first time threshold and not exceeding a configured second time threshold and the video enhancement confirmation signal representing an area edge flashing instruction, initiating the edge enhancement and canceling the edge enhancement are iteratively performed on an edge of the first video enhancement area.

If the visually-impaired people continue to press the confirmation key on the video blind cane and exceed the first time threshold by 2 seconds (does not exceed the second time threshold by 5 seconds), the video enhancement confirmation signal may represent an area edge flashing instruction, and the edge of the first video enhancement area will flash. The edge of the first video enhancement area (e.g., the edge of the portrait area) are constantly flashing, giving the visually-impaired people a strong hint to make them more clearly perceive the contour of the interesting semantic object in the image. The fourth image of FIG. 10 indicates that when the visually-impaired people press the confirmation key on the video blind cane and exceeds by 2 seconds, the edge of the portrait semantic object in the image will flash, initiating the edge enhancement and canceling the edge enhancement are iteratively performed on an edge of the first video enhancement area. In addition, for the convenience of description, the black dots of other areas are omitted here, but in practical cases, the contrast and brightness of other areas may be continuously reduced.

In 913, in response to the timing of the video enhancement confirmation signal exceeding the second time threshold, with the second time threshold value being greater than the first time threshold value, and the video enhancement confirmation signal representing an area internal flashing instruction, initiating the internal contrast and brightness enhancement and canceling the internal contrast and brightness enhancement are iteratively performed on an interior of the first video enhancement area.

If the visually-impaired people continue to press the confirmation key on the video blind cane and exceed the second time threshold by 5 seconds, the video enhancement confirmation signal may indicate an area internal flashing instruction, and the interior of the first video enhancement area may flash. The interior of the first video enhancement area is constantly flashing, giving the visually-impaired people a stronger hint to make them more clearly perceive the contour and detail of the interesting semantic object in the image. The fifth image of FIG. 10 indicates that when the visually-impaired people press the confirmation key on the video blind cane and exceeds by 5 seconds, the interior of the area of the portrait semantic object in the image will flash, and initiating the internal contrast and brightness enhancement and canceling the internal contrast and brightness enhancement are iteratively performed on an interior of the first video enhancement area. The white dots in the area indicate that the interior of the area of the portrait semantic object is flashing, and initiating the internal contrast and brightness enhancement and canceling the internal contrast and brightness enhancement are iteratively performed on an interior of the first video enhancement area.

In 914, in response to the direction extension signal, which is sent by the visually-impaired people through the video blind cane, the to-be-extended direction is obtained from the direction extension signal.

In 915, extend to the to-be-extended direction when centering on the first video enhancement area, with an extension part forming a second video enhancement area, and image enhancement is performed on the second video enhancement area.

In operations 914 to 915 above, the visually-impaired people press the direction key on the video blind cane. Since the video will be switched to the visually-impaired mode in operation 901, taking over the function of the confirmation key and direction key of the remote control apparatus; the direction key at this moment no longer performs the volume selection or other menu selection but sends a direction extension signal.

When an upward direction key is pressed, the to-be-extended direction in the direction extension signal is upward, and the second video enhancement area is an area enclosed by extending towards an upper-left corner point and an upper-right corner point of the display when centering on the first video enhancement area; when a downward direction key is pressed, the to-be-extended direction in the direction extension signal is downward, and the second video enhancement area is an area enclosed by extending towards a lower-left corner point and a lower-right corner point of the display when centering on the first video enhancement area; when a leftward direction key is pressed, the to-be-extended direction in the direction extension signal is leftward, and the second video enhancement area is an area enclosed by extending towards an upper-left corner point and a lower-left corner point of the display when centering on the first video enhancement area; when a rightward direction key is pressed, the to-be-extended direction in the direction extension signal is rightward, and the second video enhancement area is an area enclosed by extending towards an upper-right corner point and a lower-right corner point of the display when centering on the first video enhancement area.

In one or more embodiments, if the visually-impaired people press the leftward direction key, image enhancement will be performed on the text portion area on the left as the second video enhancement area. The sixth image of FIG. 10 indicates that image enhancement is performed on the text portion area on the left. Image enhancement for text semantic objects may include edge enhancement and/or area internal contrast and brightness enhancement. It may be assumed in an embodiment that only the text semantic object is subjected to edge enhancement. In an embodiment, since the text portion is enhanced, the visually-impaired people can not only clearly watch the portrait semantic object in the middle, but also further clearly watch the text semantic object on the left. In practical application, when the direction key is pressed, the confirmation key in the video blind cane may be released at the same time, and image enhancement may be canceled for the first video enhancement area. In practical application, after canceling the image enhancement, the original video image may be restored, or the first video enhancement area may be subjected to continuous image enhancement according to the image enhancement mode after switching to the visually-impaired mode. In addition, when the visually-impaired people release the direction key in the video blind cane to interrupt the direction extension signal, the image enhancement is canceled for the second video enhancement area. In practical application, the original video image may be restored after image enhancement is canceled.

In an embodiment, the direction extension signal is used as an example to illustrate how to determine the second video enhancement area according to the enhancement area change signal. In practical application, the enhancement area change signal may also be a semantic object switching signal, and visually-impaired people can switch to a new semantic object, and the image area occupied by the new semantic object is taken as a second video enhancement area. For example, in an embodiment, it may be assumed that visually-impaired people switch to a new semantic object “coffee cup” using the direction key of the video blind cane. Then, image enhancement will be performed on the coffee cup as a second video enhancement area, and the visually-impaired people can watch the coffee cup more clearly. The seventh image of FIG. 10 indicates switching to the coffee cup and performing image enhancement on the coffee cup area. As stated above, enhancement may be performed on different semantic objects with different strategies according to scene classifications and shot classifications. In an embodiment, it may be assumed that the enhancement strategies for the portrait are shown in Table 1, and the enhancement strategies for coffee cups (object) are shown in Table 5. Then, image enhancement may be performed on the portrait and the coffee cup in these two different ways, respectively. In the seventh image of FIG. 10, diagonal lines are used to indicate that image enhancement is performed on the portrait using the enhancement strategies of Table 1, and graticule lines are used to indicate that image enhancement is performed on the coffee cup using the enhancement strategy of Table 5. It is an example to illustrate that different enhancement strategies may be used for enhancement of different semantic objects. The specific parameters of contrast, brightness, filter, and dilation operator, as well as whether the edges are colored with other colors, may all be selected by a user according to actual situations, which does not serve as a limitation on the scope of the disclosure.

In addition, in an embodiment, it is illustrated that visually-impaired people press keys in the video blind cane. In practical application, the roles and functions of the keys may also be defined according to user requirements. A handle, an eyeball tracker, a mobile device, augmented reality (AR), virtual reality (VR), camera, and the like may also be used. The control may be performed according to the recognized eye movement, gesture, voice, and the like, and is not limited to which device.

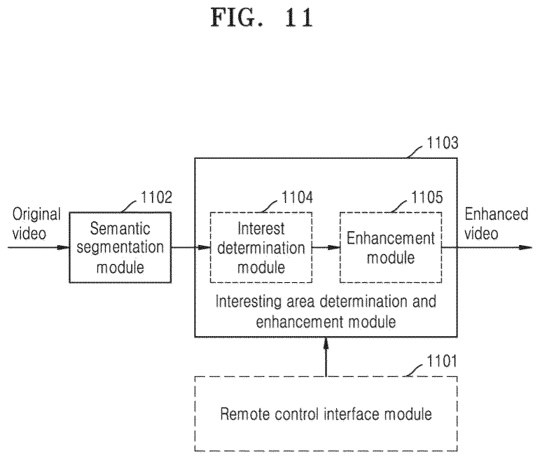

One or more embodiments provide an apparatus for video enhancement. The apparatus is applied to a scenario for visually-impaired people watching a video, where a video blind cane is used to interact with the video during visually-impaired people watching the video, and the video blind cane is an apparatus capable of performing remote control operations on the video at a display. FIG. 11 is a structural diagram of an apparatus for video enhancement according to an embodiment. As shown in FIG. 11, the apparatus includes a semantic segmentation module 1102, and an interesting area determination and enhancement module 1103.

The semantic segmentation module 1102 is configured to segment, by using a semantic segmentation technology, an original video image into a plurality of semantic objects.

The interesting area determination and enhancement module 1103 is configured to determine an interesting semantic object from a plurality of semantic objects, determine an image area occupied by the interesting semantic object as a first video enhancement area, and perform image enhancement on the first video enhancement area; perform, in response to the video enhancement confirmation signal, image enhancement on the first video enhancement area according to the configured enhancement strategy, to satisfy watching demands of the visually-impaired people on the interesting semantic object.

It may be seen that the visually-impaired people use the video blind cane to interact with the video during watching the video; the semantic segmentation module 1102 is configured to segment the original video image into a plurality of semantic objects; the interesting area determination and enhancement module 1103 is configured to determine the interesting semantic object from the plurality of semantic objects and perform image enhancement according to the configured enhancement strategy. According to an embodiment, visually-impaired people use a video blind cane to perform remote control operations on the interesting semantic object, actively exploring the video image and obtaining more detailed information, thereby improving the experience of the visually-impaired people watching a video.

In one or more embodiments, the apparatus for video enhancement further includes a remote control interface module 1101.

The remote control interface module 1101 is configured to receive a visually-impaired mode request signal and switch a video playback mode to a visually-impaired mode, the visually-impaired mode request signal being sent by the visually-impaired people through the video blind cane during interaction with the video; receive a video enhancement confirmation signal, the video enhancement confirmation signal being sent by the visually-impaired people through the video blind cane during interaction with the video.

The interesting area determination and enhancement module 1103 is further configured to switch the video playback mode to the visually-impaired mode in response to the video enhancement confirmation signal, and further perform, in response to the video enhancement confirmation signal, image enhancement on the first video enhancement area.

In one or more embodiments, the interesting area may also be extended if the visually-impaired people are not satisfied with the main part in the image and want to further watch the surrounding areas.

In an embodiment, the remote control interface module 1101 is further configured to receive an enhancement area change signal, where the enhancement area change signal is sent by the visually-impaired people through the video blind cane during interaction with the video. The interesting area determination and enhancement module 1103 is further configured to determine, in response to an enhancement area change signal, a second video enhancement area from the enhancement area change signal, and perform the image enhancement on the second video enhancement area.

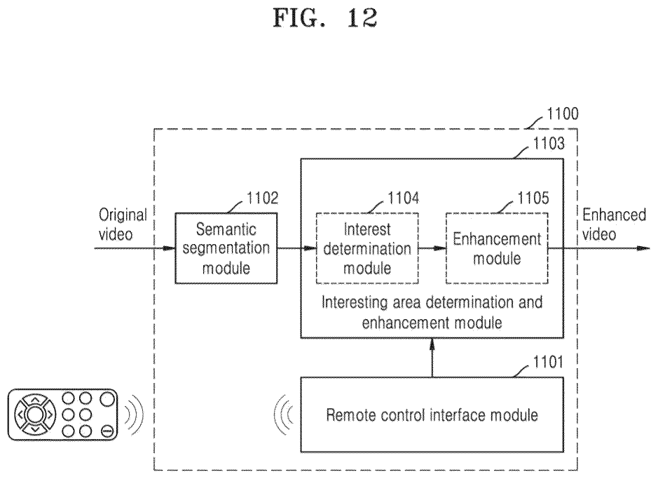

One or more embodiments provide a system for video enhancement. FIG. 12 is a structural diagram of a system for video enhancement according to an embodiment. As shown in FIG. 12, the system includes not only the apparatus for video enhancement 1100 shown in FIG. 11, but also a video blind cane 1106. The video blind cane 1106 is an apparatus capable of performing remote control operations on the video at a display, enabling the visually-impaired people to interact with the video. Some of the keys of the video blind cane 1106 are shown schematically in FIG. 2, including an on-off key 201, a mode key 202, a confirmation key 203, a direction key 204, and may also include other numeric keys. The various signals may be sent as follows: The visually-impaired mode request signal is sent by pressing a mode key in the video blind cane 1106; the video enhancement confirmation signal is sent by pressing a confirmation key in the video blind cane 1106; the enhancement area change signal is sent by pressing the direction key in video blind cane 1106.

Further, when stopping pressing the confirmation key 203 or the direction key 204, e.g., the confirmation key 203 or the direction key 204 is released, the corresponding video enhancement confirmation signal or the direction extension signal will be interrupted. In an embodiment, the apparatus for video enhancement 1100 cancels the image enhancement for the first video enhancement area in response to the interruption of the video enhancement confirmation signal generated by the visually-impaired people releasing the confirmation key in the video blind cane 1106. In practical application, after canceling the image enhancement, the original video image may be restored, or continuous image enhancement may be performed on the first video enhancement area according to the image enhancement mode after switching to the visually-impaired mode. The apparatus for video enhancement 1100 cancels the image enhancement for the second video enhancement area to restore the original video image in response to the interruption of the enhancement area change signal generated by the visually-impaired people releasing the direction key in the video blind cane 1106.

In one or more embodiments, the method for the semantic segmentation module 1102 to segment an original video image into a plurality of semantic objects is as follows.
(1) The original video image is segmented into the plurality of semantic objects, and description data of each semantic object is acquired, where the description data includes at least one of position information, semantic classification, occurrence frequency, image proportion information, image center offset value, spatial orientation distance, average light and shadow brightness value, and edge grayscale change rate.
(2) The description data of each semantic object is labelled and packaged to obtain a corresponding first semantic-object label. The acquired description data is only single data, and it is difficult to completely represent a semantic object. In an embodiment, all the description data are labelled and packaged to generate a first semantic-object label. The first semantic-object label is a description of one semantic object, and if an image is segmented into n semantic objects, n first semantic-object labels are generated. In practical application, if description data of each semantic object is acquired, the description data may not be labelled and packaged, i.e., the step is omitted.
(3) For each semantic object, the semantic object weight value is calculated according to the first semantic-object label and the configured weight operator. semantic object
(4) Each first semantic-object label is input into the neural network model to determine the scene classification and the shot classification.
(5) For each semantic object, the position information, the semantic object weight value, the scene classification, and the shot classification are packaged to generate a second semantic-object label. In practical application, as long as the position information, the semantic object weight value, the scene classification, and the shot classification are determined, the position information, semantic object weight value, scene classification, and shot classification may not be packaged to generate the second semantic-object label, that is, the step may be omitted.

In an embodiment, a semantic segmentation technology is used to segment an original video image into a plurality of semantic objects, and a second semantic-object label is acquired, so that subsequent image enhancement may be continued. In an embodiment, a first neural network is used to segment an image into a plurality of semantic objects, a second neural network is used to determine a scene classification and a shot classification, and description data and a weight operator are used to accurately calculate a first semantic-object label and a second semantic-object label, thereby improving the accuracy of subsequent image enhancement on the interesting semantic object.

In one or more embodiments, the interesting area determination and enhancement module 1103 may include an interest determination module 1104 and an enhancement module 1105. The interest determination module 1104 determines an interesting semantic object from a plurality of semantic objects, and then the enhancement module 1105 performs image enhancement on the interesting semantic object, without performing image enhancement on other parts, to highlight the interesting semantic object, which is more conducive to the watching of the visually-impaired people.

The interest determination module 1104 is implemented as follows: ranking all the semantic objects according to the semantic object weight values in the second semantic-object label; and selecting, according to a number to be enhanced, the number of semantic objects as interesting semantic objects according to the ranking. The semantic object weight value reflects the importance of the semantic object, so all the semantic objects in the image may be ranked from high to low according to the semantic object weight values. The first-ranked semantic object is the most important, followed by the second-ranked semantic object, and so on. semantic object

The enhancement module 1105 is implemented as follows: performing edge enhancement on a to-be-enhanced area using the enhancement strategy; and performing internal contrast and brightness enhancement on the to-be-enhanced area using the enhancement strategy. The edge enhancement includes: performing edge detection on the to-be-enhanced area using a filter configured in the enhancement strategy; performing edge expansion on the to-be-enhanced area using the dilation operator configured in the enhancement strategy; performing edge coloring on the to-be-enhanced area using the color configured in the enhancement strategy.

At least part of the functions in a device or electronic apparatus provided in the embodiments of the disclosure may be implemented through an AI model, such as, at least one of a plurality of modules of the device or electronic apparatus may be implemented through the AI model. A function associated with AI may be performed through the non-volatile memory, the volatile memory, and the processor.

The processor may include one or more processors. At this time, the one or more processors may be a general purpose processor, such as a central processing unit (CPU), an application processor (AP), or the like, or may be a graphics-only processing unit such as a graphics processing unit (GPU), a visual processing unit (VPU), and/or an AI-dedicated processor such as a neural processing unit (NPU).

The one or more processors control processing of input data in accordance with a predefined operating rule or artificial intelligence (AI) model stored in the non-volatile memory and the volatile memory. The predefined operating rule or artificial intelligence model is provided through training or learning.

The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Here, being provided through learning means that, by applying a learning algorithm to a plurality of learning data, a predefined operating rule or an AI model of a desired characteristic is made. The learning may be performed in a device or electronic apparatus itself in which AI according to embodiments is performed, and/or may be implemented through a separate server/system.

The AI model may include a plurality of neural network layers. Each layer has a plurality of weight values, and performs a neural network calculation by calculating between the input data of this layer (such as, a calculation result of the previous layer and/or the input data of the AI model) and the plurality of weight values of the current layer. Examples of neural networks include, but are not limited to, a convolutional neural network (CNN), a deep neural network (DNN), a recurrent neural network (RNN), a restricted Boltzmann Machine (RBM), a deep belief network (DBN), a bidirectional recurrent deep neural network (BRDNN), a generative adversarial networks (GAN), and a deep Q-network.

The one or more embodiments provide a computer-readable storage medium storing instructions that, when executed by a processor, may perform steps in the method for video enhancement as described above. In practical application, the computer-readable storage medium may be embodied in the device/apparatus/system described in the one or more embodiments above or may be separate and not incorporated into the device/apparatus/system. The computer-readable storage medium carries one or more programs that, when executed, implement the method for video enhancement described in the above embodiments. According to the one or more embodiments, the computer-readable storage medium may be a non-volatile or non-transitory computer-readable storage medium, for example, may include, but is not limited to a portable computer diskette, hard disk, random-access memory (RAM), read-only memory (ROM), erasable programmable read-only memory (EPROM or flash memory), portable compact disk read-only memory (CD-ROM), optical storage device, magnetic storage device, or any suitable combination of the above, which is not intended to limit the scope of the disclosure. In the one or more embodiments, a computer-readable storage medium may be any tangible medium that contains or stores a program that can be used by or in connection with an instruction execution system, apparatus, or device.

The one or more embodiments provide a computer program product including computer instructions that, when executed by a processor, performs the method according to any of the one or more embodiments.

The flowcharts and block diagrams in the drawings illustrate the architecture, functionality, and operation of possible implementations of systems, methods, and computer program products according to various embodiments. In this regard, each block in the flowcharts or block diagrams may represent a module, program segment, or portion of code, which includes one or more executable instructions for implementing the specified logical functions. It should also be noted that in some alternative implementations, the functions noted in the blocks may occur out of the order noted in the various drawings. For example, two connectively represented blocks may be executed substantially in parallel, or they may sometimes be executed in the reverse order, depending on the functionality involved. It will also be noted that each block in the block diagrams or flowcharts, and combinations of blocks in the block diagrams or flowcharts, may be implemented by special hardware-based systems which perform the specified functions or operations, or by combinations of special hardware and computer instructions.

It will be appreciated by the skilled in the art that various combinations of features recited in the various embodiments and/or claims of the present disclosure may be made even if such combinations are not expressly recited. Various combinations of features recited in the various embodiments and/or claims may be made without departing from the spirit of the disclosure, and all such combinations fall within the scope of the disclosure.

While principles and implementations have been described herein in connection with one or more embodiments, illustration of the foregoing embodiments is intended to aid in the understanding of the methods and principles of the present application, and is not intended to limit the disclosure. For the skilled in the art, the implementations and application scope may be changed according to the idea, spirit, and principle of the disclosure, and any modification, equivalent replacement, and improvement made by those skilled in the art shall be included in the scope of the disclosure.

According to an aspect of the disclosure, there is provided a method for video enhancement including: segmenting, using a semantic segmentation technology, an original video image into a plurality of semantic subjects; identifying a first semantic subject from the plurality of semantic subjects, and identifying an image area corresponding to the first semantic subject as a first video enhancement area; performing image enhancement on the first video enhancement area according to a configured enhancement strategy, based on watching patterns of a user; and providing an enhanced image to a display based on the image enhancement.

In one or more embodiments of the disclosure, the video blind cane is used to interact with the video in the process of watching a video to achieve video enhancement; a semantic segmentation technology is used to segment an original video image into a plurality of semantic subjects, a signal is sent through the video blind cane, and an image area occupied by an interesting semantic subject is taken as a first video enhancement area for image enhancement. The interactivity between the visually-impaired people and the video is increased, rather than the visually-impaired people passively receiving the video, so that the visually-impaired people use the video blind cane to perform remote control operations on the interesting semantic subject and actively explore the video image to obtain more detailed information, thereby improving the experience of the visually-impaired people watching a video.

The method may include, based on receiving a visually-impaired mode request signal before the segmenting, switching a video playback mode to a visually-impaired mode, the visually-impaired mode request signal being from the user through a video blind cane during interaction with a video.

The method may include, based on receiving a video enhancement confirmation signal after performing the image enhancement according to the configured enhancement strategy, performing further image enhancement on the first video enhancement area, the video enhancement confirmation signal being received from the user through the video blind cane during interaction with the video.

The method may include, based on receiving an enhancement area change signal after the performing the further image enhancement, identifying a second video enhancement area from the enhancement area change signal, and performing image enhancement on the second video enhancement area, the enhancement area change signal being received from the user through the video blind cane during interaction with the video.

The enhancement area change signal may be a direction extension signal, and wherein the identifying the second video enhancement area from the enhancement area change signal may include: acquiring a to-be-extended direction from the direction extension signal; and extending towards the to-be-extended direction when centering on the first video enhancement area, wherein an extension part forms the second video enhancement area.

The method may include, based on the to-be-extended direction in the direction extension signal being upward, the second video enhancement area may be an area enclosed by extending towards an upper-left corner point and an upper-right corner point of the display when centering on the first video enhancement area; based on the to-be-extended direction in the direction extension signal being downward, the second video enhancement area may be an area enclosed by extending towards a lower-left corner point and a lower-right corner point of the display when centering on the first video enhancement area; based on the to-be-extended direction in the direction extension signal being leftward, the second video enhancement area may be an area enclosed by extending towards the upper-left corner point and the lower-left corner point of the display when centering on the first video enhancement area; and based on the to-be-extended direction in the direction extension signal being rightward, the second video enhancement area may be an area enclosed by extending towards the upper-right corner point and the lower-right corner point of the display when centering on the first video enhancement area.

The enhancement area change signal may be a semantic subject switching signal, and wherein the identifying the second video enhancement area from the enhancement area change signal may include: acquiring a direction of a new semantic subject from the semantic subject switching signal; and switching to the direction of the new semantic subject when centering on the first video enhancement area, and taking an image area occupied by the new semantic subject as the second video enhancement area.

The visually-impaired mode request signal may be sent from the user by pressing a mode key in the video blind cane, wherein the video enhancement confirmation signal may be sent from the user by pressing a confirmation key in the video blind cane, and wherein the enhancement area change signal may be sent from the user by pressing a direction key in the video blind cane.

The method may include, based on interruption of the video enhancement confirmation signal, canceling the performing further image enhancement for the first video enhancement area based on interruption of the video enhancement confirmation signal; and based on interruption of the enhancement area change signal, canceling the image enhancement for the second video enhancement area.

The segmenting the original video image into the plurality of semantic subjects may include: acquiring description data of each semantic subject, wherein the description data represents information describing the semantic subject; identifying, for the each semantic subject, a semantic subject weight value according to the description data and a configured weight operator; and inputting the description data of the each semantic subject into a neural network model to identify a scene classification and a shot classification.

The description data may include position information, semantic classification, occurrence frequency, image proportion information, image center offset value, spatial orientation distance, average light and shadow brightness value, and edge grayscale change rate, and wherein between the acquiring the description data of each semantic subject and the identifying, for each semantic subject, the semantic subject weight value according to the description data and the configured weight operator, the method further may include: labelling and packaging the description data of the each semantic subject to obtain a corresponding first semantic-subject label; and after obtaining the position information, the semantic subject weight value, the scene classification, and the shot classification of each segmented semantic subject, the method further may include: packaging, for the each semantic subject, the position information, the semantic subject weight value, the scene classification, and the shot classification to generate a second semantic-subject label.

The identifying the first semantic subject from the plurality of semantic subjects may include: ranking the semantic subjects according to semantic subject weight values; and selecting, according to a number to be enhanced, a number of semantic subjects as first semantic subjects according to the ranking.

The performing image enhancement may include: performing edge enhancement on a to-be-enhanced area using an enhancement strategy; or performing internal contrast and brightness enhancement on the to-be-enhanced area using the enhancement strategy.

The enhancement strategy may include: performing image enhancement separately on scene classifications and shot classifications, wherein the enhancement strategy may be configured according to the scene classifications and the shot classifications, and wherein a scene classification indicates a scene represented by the semantic subject, and a shot classification indicates a difference of a range size displayed by a semantic subject on an image when a focal length is fixed.

The performing image enhancement separately on the scene classifications and the shot classifications may include: for a semantic subject of which scene classification may be portrait, scenery, animal, or object, based on the semantic subject being farther away from a lens in the shot classification, the internal contrast, brightness, and a dilation operator are larger, and a sensitivity parameter of a filter may be smaller; and for a semantic subject of which scene classification is traffic, based on the semantic subject being farther away from a lens in the shot classification, the internal contrast, the brightness, and the sensitivity parameter of the filter are larger, and the dilation operator may be smaller.

The performing edge enhancement on the to-be-enhanced area using the enhancement strategy may include: performing edge detection on the to-be-enhanced area using a filter configured in the enhancement strategy; performing edge expansion on the to-be-enhanced area using a dilation operator configured in the enhancement strategy; and performing edge coloring on the to-be-enhanced area using a color configured in the enhancement strategy.

The performing further image enhancement on the first video enhancement area may include: timing a video enhancement confirmation signal; and based on the timing of the video enhancement confirmation signal not exceeding a configured first time threshold and the video enhancement confirmation signal representing an instruction of enhancing the internal contrast and the brightness, performing further image enhancement on the first video enhancement area based on previous enhancement and by increasing an enhancement standard, the enhancement standard may include the internal contrast and brightness; and reducing the internal contrast and the brightness of other areas except the first video enhancement area.

The method may include, based on the timing of the video enhancement confirmation signal exceeding the configured first time threshold and not exceeding a configured second time threshold, the second time threshold being greater than the first time threshold, the performing further image enhancement on the first video enhancement area further may include: based on the video enhancement confirmation signal representing an area edge flashing instruction, iteratively performing initiating the edge enhancement and canceling the edge enhancement on an edge of the first video enhancement area.

Based on the timing of the video enhancement confirmation signal exceeding the second time threshold, the performing further image enhancement on the first video enhancement area further may include: based on the video enhancement confirmation signal representing an area internal flashing instruction, iteratively performing initiating the internal contrast and the brightness enhancement and canceling the internal contrast and the brightness enhancement on an interior of the first video enhancement area.

According to an aspect of the disclosure, there is provided an apparatus for video enhancement including: memory storing instructions; and at least one processor, wherein the instructions, when executed by the at least one processor, cause the apparatus to: segment, using a semantic segmentation technology, an original video image into a plurality of semantic subjects; and identify a first semantic subject from the plurality of semantic subjects, and identify an image area corresponding to the first semantic subject as a first video enhancement area; perform image enhancement on the first video enhancement area according to a configured enhancement strategy, based on watching patterns of a user; and provide an enhanced image to a display based on the image enhancement.

The instructions, when executed by the at least one processor, may cause the apparatus to: based on receiving a visually-impaired mode request signal, switch a video playback mode to a visually-impaired mode, the visually-impaired mode request signal being received from the user through a video blind cane during interaction with the video; receive a video enhancement confirmation signal from the user through the video blind cane during interaction with the video; and based on the video enhancement confirmation signal, perform further image enhancement on the first video enhancement area.

The instructions, when executed by the at least one processor, may cause the apparatus to: receive an enhancement area change signal, the enhancement area change signal being received from the user through a video blind cane during interaction with the video; and based on the enhancement area change signal, identify a second video enhancement area from the enhancement area change signal, and perform the image enhancement on the second video enhancement area.

According to an aspect of the disclosure, there is provided a system for video enhancement including: a video blind cane to interact with a video; and an electronic device including: memory storing instructions; and at least one processor, wherein the instructions, when executed by the at least one processor, cause the electronic device to: segment, using a semantic segmentation technology, an original video image into a plurality of semantic subjects; and identify a first semantic subject from the plurality of semantic subjects, and identify an image area corresponding to the first semantic subject as a first video enhancement area; perform image enhancement on the first video enhancement area according to a configured enhancement strategy, based on watching patterns of a user; and provide an enhanced image to a display based on the image enhancement.

The video blind cane may be configured to send a visually-impaired mode request signal, a video enhancement confirmation signal, and an enhancement area change signal, which are triggered by the user during interaction with the video. According to an aspect of the disclosure, there may be provided a non-transitory computer-readable storage medium, storing thereon computer instructions, the instructions, when executed by a processor, cause the processor to perform a method may include: segmenting, using a semantic segmentation technology, an original video image into a plurality of semantic subjects; identifying a first semantic subject from the plurality of semantic subjects, and identifying an image area corresponding to the first semantic subject as a first video enhancement area; performing image enhancement on the first video enhancement area according to a configured enhancement strategy, based on watching patterns of a user; and providing an enhanced image to a display based on the image enhancement.

According to an aspect of the disclosure, there is provided a non-transitory computer program product, including computer instructions, the instructions, when executed by a processor, cause the processor to perform a method including: segmenting, using a semantic segmentation technology, an original video image into a plurality of semantic subjects; identifying a first semantic subject from the plurality of semantic subjects, and identifying an image area corresponding to the first semantic subject as a first video enhancement area; performing image enhancement on the first video enhancement area according to a configured enhancement strategy, based on watching patterns of a user; and providing an enhanced image to a display based on the image enhancement.

According to an embodiment of the disclosure, the method may include segmenting, using a semantic segmentation technology, an original image into a plurality of semantic objects. According to an embodiment of the disclosure, the method may include identifying a first semantic object from the plurality of semantic object. According to an embodiment of the disclosure, the method may include identifying a first image area corresponding to the first semantic object as a first enhancement area. According to an embodiment of the disclosure, the method may include performing image enhancement on the first enhancement area according to a configured enhancement strategy. According to an embodiment of the disclosure, the method may include providing an enhanced image to a display based on the image enhancement.

According to an embodiment of the disclosure, the method may include receiving an enhancement area change signal through a remote-control device. According to an embodiment of the disclosure, the method may include, based on receiving the enhancement area change signal, identifying a second enhancement area from the enhancement area change signal. According to an embodiment of the disclosure, the method may include performing image enhancement on the second enhancement area.

According to an embodiment of the disclosure, the enhancement area change signal may be a direction extension signal. According to an embodiment of the disclosure, the method may include acquiring a to-be-extended direction from the direction extension signal. According to an embodiment of the disclosure, the method may include extending towards the to-be-extended direction when centering on the first enhancement area, wherein an extension part forms the second enhancement area.

According to an embodiment of the disclosure, the method may include, based on the to-be-extended direction in the direction extension signal being upward, extending towards an upper-left corner point and an upper-right corner point of the display when centering on the first enhancement area. According to an embodiment of the disclosure, the method may include, based on the to-be-extended direction in the direction extension signal being downward, extending towards a lower-left corner point and a lower-right corner point of the display when centering on the first enhancement area. According to an embodiment of the disclosure, the method may include, based on the to-be-extended direction in the direction extension signal being leftward, extending towards the upper-left corner point and the lower-left corner point of the display when centering on the first enhancement area. According to an embodiment of the disclosure, the method may include, based on the to-be-extended direction in the direction extension signal being rightward, extending towards the upper-right corner point and the lower-right corner point of the display when centering on the first enhancement area. According to an embodiment of the disclosure, the method may include obtaining an area enclosed by the extended towards the to-be-extended direction as the second enhancement area.

According to an embodiment of the disclosure, the enhancement area change signal may be a semantic object switching signal. According to an embodiment of the disclosure, the method may include acquiring a direction of a new semantic object from the semantic object switching signal. According to an embodiment of the disclosure, the method may include switching to the direction of the new semantic object when centering on the first enhancement area. According to an embodiment of the disclosure, the method may include identifying a second image area corresponding to the new semantic object as the second enhancement area.

According to an embodiment of the disclosure, the method may include acquiring description data of each semantic object. According to an embodiment of the disclosure, the description data may represent information describing the semantic object. According to an embodiment of the disclosure, the method may include identifying, for the each semantic object, a semantic object weight value according to the description data and a configured weight operator. According to an embodiment of the disclosure, the method may include identifying a scene classification and a shot classification by inputting the description data of the each semantic object into a neural network model.

According to an embodiment of the disclosure, the description data may include at least one of position information, semantic classification, occurrence frequency, image proportion information, image center offset value, spatial orientation distance, average light and shadow brightness value, and edge grayscale change rate. According to an embodiment of the disclosure, the method may include labelling the description data of the each semantic object to obtain a corresponding first semantic-object label. According to an embodiment of the disclosure, the method may include packaging, for the each semantic object, the position information, the semantic object weight value, the scene classification, and the shot classification to generate a second semantic-object label.

According to an embodiment of the disclosure, the method may include performing edge enhancement on a to-be-enhanced area using an enhancement strategy. According to an embodiment of the disclosure, the method may include performing internal contrast and brightness enhancement on the to-be-enhanced area using the enhancement strategy.

According to an embodiment of the disclosure, the method may include performing image enhancement separately on scene classifications and shot classifications. According to an embodiment of the disclosure, the enhancement strategy may be configured according to the scene classifications and the shot classifications. According to an embodiment of the disclosure, a scene classification may indicate a scene represented by the semantic object. According to an embodiment of the disclosure, a shot classification may indicate a difference of a range size displayed by a semantic object on an image when a focal length is fixed.

According to an embodiment of the disclosure, the method may include, for a semantic object of which scene classification is portrait, scenery, animal, or object, based on the semantic object being farther away from a lens in the shot classification, increasing the internal contrast, brightness, and a dilation operator, and decreasing a sensitivity parameter of a filter. According to an embodiment of the disclosure, the method may include, for a semantic object of which scene classification is traffic, based on the semantic object being farther away from a lens in the shot classification, increasing the internal contrast, the brightness, and the sensitivity parameter of the filter, and decreasing the dilation operator.

According to an embodiment of the disclosure, the method may include performing edge detection on the to-be-enhanced area using a filter configured in the enhancement strategy. According to an embodiment of the disclosure, the method may include performing edge expansion on the to-be-enhanced area using a dilation operator configured in the enhancement strategy. According to an embodiment of the disclosure, the method may include performing edge coloring on the to-be-enhanced area using a color configured in the enhancement strategy.

According to an embodiment of the disclosure, an electronic apparatus may be provided. The electronic apparatus may include at least one processor including processing circuitry, memory storing instructions that, when executed by the at least one processor individually or collectively. The at least one processor may cause the electronic apparatus to segment, using a semantic segmentation technology, an original image into a plurality of semantic objects. The at least one processor may cause the electronic apparatus to identify a first semantic object from the plurality of semantic objects, and identify a first image area corresponding to the first semantic object as a first enhancement area. The at least one processor may cause the electronic apparatus to perform image enhancement on the first enhancement area according to a configured enhancement strategy. The at least one processor may cause the electronic apparatus to provide an enhanced image to a display based on the image enhancement.

According to the embodiment of the disclosure, the at least one processor may cause the electronic apparatus to receive an enhancement area change signal through a remote-control device. The at least one processor may cause the electronic apparatus to, based on receiving the enhancement area change signal, identify a second enhancement area from the enhancement area change signal. The at least one processor may cause the electronic apparatus to perform image enhancement on the second enhancement area.

According to the embodiment of the disclosure, the enhancement area change signal may be a direction extension signal. The at least one processor may cause the electronic apparatus to acquire a to-be-extended direction from the direction extension signal. The at least one processor may cause the electronic apparatus to extend towards the to-be-extended direction when centering on the first enhancement area, wherein an extension part forms the second enhancement area.

According to the embodiment of the disclosure, the enhancement area change signal may be a semantic object switching signal. The at least one processor may cause the electronic apparatus to acquire a direction of a new semantic object from the semantic object switching signal. The at least one processor may cause the electronic apparatus to switch to the direction of the new semantic object when centering on the first enhancement area. The at least one processor may cause the electronic apparatus to identify a second image area corresponding to the new semantic object as the second enhancement area.

According to the embodiment of the disclosure, the at least one processor may cause the electronic apparatus to acquire description data of each semantic object, wherein the description data represents information describing the semantic object. The at least one processor may cause the electronic apparatus to identify, for the each semantic object, a semantic object weight value according to the description data and a configured weight operator. The at least one processor may cause the electronic apparatus to identify a scene classification and a shot classification by inputting the description data of the each semantic object into a neural network model.

According to the embodiment of the disclosure, the at least one processor may cause the electronic apparatus to perform edge enhancement on a to-be-enhanced area using an enhancement strategy. The at least one processor may cause the electronic apparatus to perform internal contrast and brightness enhancement on the to-be-enhanced area using the enhancement strategy.

According to the embodiment of the disclosure, the at least one processor may cause the electronic apparatus to perform image enhancement separately on scene classifications and shot classifications. According to the embodiment of the disclosure, the enhancement strategy may be configured according to the scene classifications and the shot classifications. According to the embodiment of the disclosure, a scene classification may indicate a scene represented by the semantic object. According to the embodiment of the disclosure, a shot classification may indicate a difference of a range size displayed by a semantic object on an image when a focal length is fixed.

According to the embodiment of the disclosure, the at least one processor may cause the electronic apparatus to perform edge detection on the to-be-enhanced area using a filter configured in the enhancement strategy. The at least one processor may cause the electronic apparatus to perform edge expansion on the to-be-enhanced area using a dilation operator configured in the enhancement strategy. The at least one processor may cause the electronic apparatus to perform edge coloring on the to-be-enhanced area using a color configured in the enhancement strategy.

According to an embodiment of the disclosure, a computer-readable storage medium storing instruction that, when executed by at least one processor, cause the at least one processor to segment, using a semantic segmentation technology, an original image into a plurality of semantic objects. The computer-readable storage medium storing instruction that, when executed by at least one processor, cause the at least one processor to identify a first semantic object from the plurality of semantic object. The computer-readable storage medium storing instruction that, when executed by at least one processor, cause the at least one processor to identify a first image area corresponding to the first semantic object as a first enhancement area. The computer-readable storage medium storing instruction that, when executed by at least one processor, cause the at least one processor to perform image enhancement on the first enhancement area according to a configured enhancement strategy, based on watching patterns of a user. The computer-readable storage medium storing instruction that, when executed by at least one processor, cause the at least one processor to provide an enhanced image to a display based on the image enhancement.

What is claimed is:

1. A method for image enhancement, the method comprising:
segmenting, using a semantic segmentation technology, an original image into a plurality of semantic objects;
identifying a first semantic object from the plurality of semantic object;
identifying a first image area corresponding to the first semantic object as a first enhancement area;
performing image enhancement on the first enhancement area according to a configured enhancement strategy; and
providing an enhanced image to a display based on the image enhancement.

2. The method according to claim 1,
further comprising:
receiving an enhancement area change signal through a remote-control device;
based on receiving the enhancement area change signal, identifying a second enhancement area from the enhancement area change signal; and
performing image enhancement on the second enhancement area.

3. The method according to claim 2,
wherein the enhancement area change signal is a direction extension signal, and
wherein the identifying the second enhancement area from the enhancement area change signal comprises:
acquiring a to-be-extended direction from the direction extension signal; and
extending towards the to-be-extended direction when centering on the first enhancement area, wherein an extension part forms the second enhancement area.

4. The method according to claim 3, wherein extending towards the to-be-extended direction when centering on the first enhancement area comprises:
based on the to-be-extended direction in the direction extension signal being upward, extending towards an upper-left corner point and an upper-right corner point of the display when centering on the first enhancement area;
based on the to-be-extended direction in the direction extension signal being downward, extending towards a lower-left corner point and a lower-right corner point of the display when centering on the first enhancement area;
based on the to-be-extended direction in the direction extension signal being leftward, extending towards the upper-left corner point and the lower-left corner point of the display when centering on the first enhancement area;
based on the to-be-extended direction in the direction extension signal being rightward, extending towards the upper-right corner point and the lower-right corner point of the display when centering on the first enhancement area; and
obtaining an area enclosed by the extended towards the to-be-extended direction as the second enhancement area.

5. The method according to claim 2, wherein the enhancement area change signal is a semantic object switching signal, and
wherein the identifying the second enhancement area from the enhancement area change signal comprises:
acquiring a direction of a new semantic object from the semantic object switching signal;
switching to the direction of the new semantic object when centering on the first enhancement area; and
identifying a second image area corresponding to the new semantic object as the second enhancement area.

6. The method according to claim 1, wherein the segmenting the original image into the plurality of semantic objects comprises:
acquiring description data of each semantic object, wherein the description data represents information describing the semantic object;
identifying, for the each semantic object, a semantic object weight value according to the description data and a configured weight operator; and
identifying a scene classification and a shot classification by inputting the description data of the each semantic object into a neural network model.

7. The method according to claim 6, wherein the description data comprises at least one of position information, semantic classification, occurrence frequency, image proportion information, image center offset value, spatial orientation distance, average light and shadow brightness value, and edge grayscale change rate, and
wherein identifying, for the each semantic object, the semantic object weight value according to the description data and a configured weight operator comprises:
labelling the description data of the each semantic object to obtain a corresponding first semantic-object label; and
packaging, for the each semantic object, the position information, the semantic object weight value, the scene classification, and the shot classification to generate a second semantic-object label.

8. The method according to claim 1, wherein the performing image enhancement comprises: at least one of:
performing edge enhancement on a to-be-enhanced area using an enhancement strategy; or
performing internal contrast and brightness enhancement on the to-be-enhanced area using the enhancement strategy.

9. The method according to claim 8, wherein the enhancement strategy comprises:
performing image enhancement separately on scene classifications and shot classifications,
wherein the enhancement strategy is configured according to the scene classifications and the shot classifications, and
wherein a scene classification indicates a scene represented by the semantic object, and a shot classification indicates a difference of a range size displayed by a semantic object on an image when a focal length is fixed.

10. The method according to claim 9, wherein the performing image enhancement separately on the scene classifications and the shot classifications comprises:
for a semantic object of which scene classification is portrait, scenery, animal, or object, based on the semantic object being farther away from a lens in the shot classification, increasing the internal contrast, brightness, and a dilation operator, and decreasing a sensitivity parameter of a filter; and
for a semantic object of which scene classification is traffic, based on the semantic object being farther away from a lens in the shot classification, increasing the internal contrast, the brightness, and the sensitivity parameter of the filter, and decreasing the dilation operator.

11. The method according to claim 8, wherein the performing edge enhancement on the to-be-enhanced area using the enhancement strategy comprises:
performing edge detection on the to-be-enhanced area using a filter configured in the enhancement strategy;
performing edge expansion on the to-be-enhanced area using a dilation operator configured in the enhancement strategy; and
performing edge coloring on the to-be-enhanced area using a color configured in the enhancement strategy.

12. An apparatus for image enhancement comprising:
memory storing instructions; and
at least one processor,
wherein the instructions, when executed by the at least one processor individually or collectively, cause the apparatus to:
segment, using a semantic segmentation technology, an original image into a plurality of semantic objects; and
identify a first semantic object from the plurality of semantic objects, and identify a first image area corresponding to the first semantic object as a first enhancement area;
perform image enhancement on the first enhancement area according to a configured enhancement strategy; and
provide an enhanced image to a display based on the image enhancement.

13. The apparatus according to claim 12,
wherein the instructions, when executed by the at least one processor individually or collectively, further cause the apparatus to:
receive an enhancement area change signal through a remote-control device;
based on receiving the enhancement area change signal, identify a second enhancement area from the enhancement area change signal; and
perform image enhancement on the second enhancement area.

14. The apparatus according to claim 13,
wherein the enhancement area change signal is a direction extension signal, and
wherein the instructions, when executed by the at least one processor individually or collectively, further cause the apparatus to:
acquire a to-be-extended direction from the direction extension signal; and
extend towards the to-be-extended direction when centering on the first enhancement area, wherein an extension part forms the second enhancement area.

15. The apparatus according to claim 13,
wherein the enhancement area change signal is a semantic object switching signal, and
wherein the instructions, when executed by the at least one processor individually or collectively individually or collectively, further cause the apparatus to:
acquire a direction of a new semantic object from the semantic object switching signal;
switch to the direction of the new semantic object when centering on the first enhancement area; and
identify a second image area corresponding to the new semantic object as the second enhancement area.

16. The apparatus according to claim 12,
wherein the instructions, when executed by the at least one processor individually or collectively, further cause the apparatus to:
acquire description data of each semantic object, wherein the description data represents information describing the semantic object;
identify, for the each semantic object, a semantic object weight value according to the description data and a configured weight operator; and
identify a scene classification and a shot classification by inputting the description data of the each semantic object into a neural network model.

17. The apparatus according to claim 12,
wherein the instructions, when executed by the at least one processor individually or collectively, further cause the apparatus to:
at least one of:
perform edge enhancement on a to-be-enhanced area using an enhancement strategy; or
perform internal contrast and brightness enhancement on the to-be-enhanced area using the enhancement strategy.

18. The apparatus according to claim 17,
wherein the instructions, when executed by the at least one processor individually or collectively, further cause the apparatus to:
perform image enhancement separately on scene classifications and shot classifications,
wherein the enhancement strategy is configured according to the scene classifications and the shot classifications, and
wherein a scene classification indicates a scene represented by the semantic object, and a shot classification indicates a difference of a range size displayed by a semantic object on an image when a focal length is fixed.

19. The apparatus according to claim 17,
wherein the instructions, when executed by the at least one processor individually or collectively, further cause the apparatus to:
perform edge detection on the to-be-enhanced area using a filter configured in the enhancement strategy;
perform edge expansion on the to-be-enhanced area using a dilation operator configured in the enhancement strategy; and
perform edge coloring on the to-be-enhanced area using a color configured in the enhancement strategy.

20. A non-transitory computer-readable storage medium, storing thereon computer instructions, the instructions, when executed by at least one processor, cause the at least one processor to perform a method comprising:
segmenting, using a semantic segmentation technology, an original image into a plurality of semantic objects;
identifying a first semantic object from the plurality of semantic object;
identifying a first image area corresponding to the first semantic object as a first enhancement area;
performing image enhancement on the first enhancement area; and
providing an enhanced image to a display based on the image enhancement.
